(19) United States
(12) Patent Application Publication
(10) Pub. No.: US 2016/0139460 A1
(43) Pub. Date: May 19, 2016

(54) DISPLAY DEVICE

(71) Applicant: SHARP KABUSHIKI KAISHA, Osaka-shi (JP)

(72) Inventor: Kenji Takase, Osaka-shi (JP)

(21) Appl. No.: 14/899,195

(22) PCT Filed: Mar. 3, 2014
(86) PCT No.: PCT/JP2014/055305

§ 371 Date: Dec. 17, 2015

(30) Foreign Application Priority Data
Sep. 19, 2013 (JP) 2013-194061

(51) Int. Cl. G02F 1/1335; G02B 3/08; G02B 1/04; G02B 27/02; G02B 3/04

(52) U.S. Cl. CPC G02F 1/133526; G02B 27/022; G02B 3/04; G02B 1/041; G02B 3/08

(57) ABSTRACT

The object is to provide a display device that makes a width of a casing look narrower than the actual width thereof or makes the width invisible by using a background image of an installation site and thereby produces a sense of unity with a background. The display device includes a display unit, the casing that is provided on a periphery of the display unit, and a lens that includes a front surface portion which is provided on at least a part of a front surface of the casing and sloped so as to protrude toward a front surface side with respect to a direction from inside to outside of the casing and a back surface portion which protrudes to the outside of the casing when viewed from a back surface side and emits the background image, behind the back surface portion, from the front surface portion.

### TECHNICAL FIELD

The present invention relates to a display device that includes a casing in a shape of a picture frame.

### BACKGROUND ART

In display devices such as liquid crystal display devices, commonly, components are fixed by holding a non-display region on a periphery of a display unit with a casing (such as a front frame or a cabinet) in the shape of a picture frame. There has been a problem in that the presence of the casing highlights a partition in the shape of the picture frame and thereby causes a sensation of disunity between an image on the display unit and a background outside the display device. There has been another problem in that the design is thereby impaired. Therefore, various frame narrowing technologies have been proposed that decrease the width of the casing or that make the casing look narrower.

In PTL 1, for instance, a liquid crystal display device is disclosed in which a non-display region (picture frame) on a periphery of a display screen is eliminated, so that an image can be displayed on an entire surface thereof. In the liquid crystal display device, an image enlarging panel is provided on a front surface that includes a front bezel, and a viewing angle widening panel is provided on a front surface of the image enlarging panel.

### CITATION LIST

### Patent Literature

PTL 1: Japanese Unexamined Patent Application Publication No. 2013-44899

### SUMMARY OF INVENTION

### Technical Problem

In PTL 1, however, an image is distorted so as to cause a sense of incongruity because the image in the vicinity of the picture frame is refracted through the image enlarging panel and because transmitted light is scattered by the viewing angle widening panel. When a linear image is displayed, in particular, the image is distorted so as to be bent and the sense of incongruity is thereby increased. Moreover, the image in the vicinity of the corners of the front bezel is synthesized from images from two sides, and thus differs from a normal image. There has been another problem in that the enlargement of a display region causes a decrease in luminance of an enlarged peripheral part.

An object of the invention is to provide a display device that makes a width of a casing look narrower than the actual width thereof or makes the width invisible through the agency of a background image of an installation site and that thereby produces a sense of unity with the background.

### Solution to Problem

In order to achieve the object, a display device of the invention includes a display unit, a casing that is provided on a periphery of the display unit, and a lens that includes a front surface portion which is provided on at least a part of a front surface of the casing and which is sloped so as to protrude toward a front surface side with respect to a direction from inside to outside of the casing, the lens also including a back surface portion which protrudes to the outside of the casing when viewed from a back surface side, and emitting a background image, which is behind the back surface portion, from the front surface portion.

### Advantageous Effects of Invention

According to the present invention, the width of the casing is made to look narrower than the actual width thereof or is made invisible through the agency of the background image of the installation site for the display device, and thus a sense of unity with the background can be produced.

### BRIEF DESCRIPTION OF DRAWINGS

FIG. 1 is a front view of a configuration of the major parts of a liquid crystal display device according to a first embodiment.

FIG. 2 is a bottom view of the configuration of the major parts of the liquid crystal display device according to the first embodiment.

FIG. 3 is a cross-sectional view taken along line A-A in FIG. 1.

FIG. 4 is a front view of a lens according to the first embodiment.

FIG. 5 is a front view of a liquid crystal module according to the first embodiment.

FIG. 6 is an enlarged view of a vicinity of the lens of FIG. 3.

FIG. 7 is a front view of a configuration of the major parts of a liquid crystal display device according to a second embodiment.

FIG. 8 is a bottom view of the configuration of the major parts of the liquid crystal display device according to the second embodiment.

FIG. 9 is a cross-sectional view taken along line B-B in FIG. 7.

FIG. 10 is an enlarged view of a vicinity of a lens of FIG. 9.

FIG. 11 is a cross-sectional view of a liquid crystal display device according to a third embodiment.

FIG. 12 is an enlarged view of a vicinity of a lens of FIG. 11.

FIG. 13 is a front view of a configuration of the major parts of a liquid crystal display device according to an eighth embodiment.

FIG. 14 is a bottom view of the configuration of the major parts of the liquid crystal display device according to the eighth embodiment.

FIG. 15 is a cross-sectional view taken along line C-C in FIG. 13.

FIG. 16 is an enlarged view of a vicinity of a lens of FIG. 15.

FIG. 17 is a front view of a configuration of the major parts of a liquid crystal display device according to a ninth embodiment.

FIG. 18 is a cross-sectional view taken along line D-D in FIG. 17.

FIG. 19 is a cross-sectional view taken along line E-E in FIG. 17.

### DESCRIPTION OF EMBODIMENTS

Hereinafter, embodiments of the invention will be described with reference to the drawings. Members common to the embodiments are designated by the same reference characters and duplicate descriptions are omitted. Configurations of the embodiments may be combined to the extent possible. Though examples of display devices that are liquid crystal display devices will be described below, the invention is not be limited thereto and can be applied to various display devices such as organic or inorganic electroluminescence (EL) display devices.

### First Embodiment

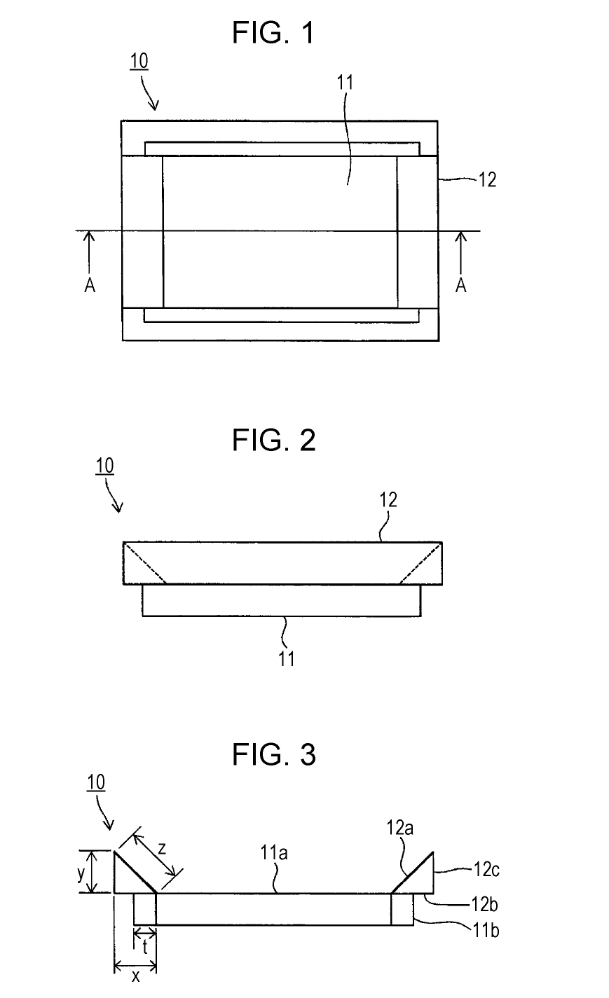

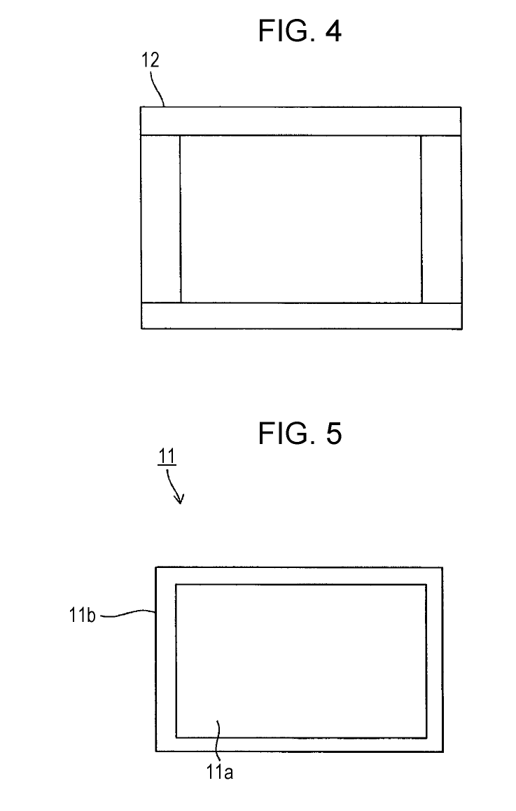

FIG. 1 is a front view of a configuration of major parts of a liquid crystal display device according to the first embodiment of the invention; FIG. 2 is a bottom view of the same; FIG. 3 is a cross-sectional view taken along line A-A in FIG. 1; FIG. 4 is a front view of a lens according to the first embodiment; and FIG. 5 is a front view of a liquid crystal module according to the first embodiment.

As illustrated in FIGS. 1 through 5, a liquid crystal display device 10 of the first embodiment includes a liquid crystal module 11 and a lens 12. The liquid crystal module 11 includes a display unit 11a that has a liquid crystal panel, a backlight, various optical films, and the like and a front frame (casing) 11b that is in the shape of a picture frame, that is provided in a non-display region on the periphery of the display unit 11a, and that holds and fixes the display unit 11a. The lens 12 is a piece of glass in the shape of a picture frame and is provided so as to cover a front surface of the front frame 11b.

In the lens 12, out of the four sides, both the left and right sides have a triangular shape in a cross-section, and each have a planar front surface portion 12a that is sloped so as to protrude toward a front surface side with respect to a direction from inside to outside of the front frame 11b, a planar back surface portion 12b that protrudes to the outside of the front frame 11b when viewed from a back surface side, and a planar side surface portion 12c that links the front surface portion 12a and the back surface portion 12b. A background image behind the back surface portion 12b is emitted from the front surface portion 12a. A slope of the front surface portion 12a only has to be formed on at least a part thereof that overlaps the front frame 11b, and an outside part that does not overlap the front frame 11b may have no slope. The top and bottom two sides of the lens 12 have a rectangular shape in a cross-section.

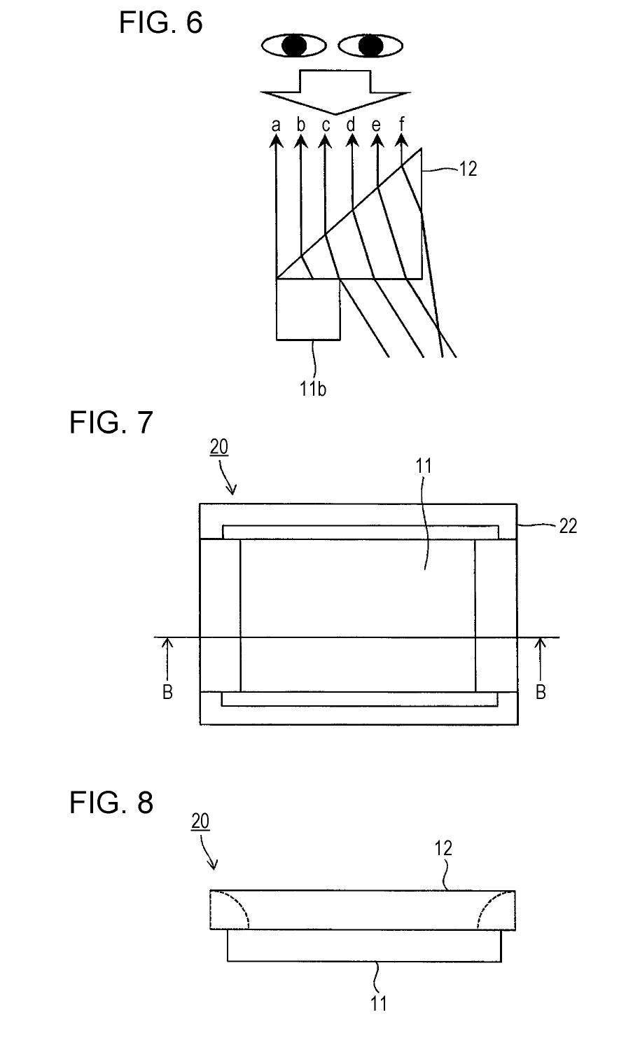

A mechanism of the emission of the background image will be described in reference to FIG. 6. FIG. 6 is an enlarged view of a vicinity of the lens 12 of FIG. 3. When viewed from the frontal perspective of a viewer watching the front surface side, among the light rays a through f that are emitted from the front surface portion 12a of the lens 12, the light rays a and b, which are emitted from the part that overlaps with the front frame 11b, form an image on the front frame 11b as viewed from the frontal perspective. The light ray c, which is emitted from the part that overlaps with the front frame 11b as viewed from the frontal perspective, and the light rays d through f, which are emitted from the part outside the front frame 11b as viewed from the frontal perspective, form the background image behind the liquid crystal display device 10.

Therefore, the width of the front frame 11b appears narrower than the actual width thereof to the viewer because the light ray c, which is emitted from the part that overlaps the front frame 11b as viewed from the frontal perspective of the lens 12, forms the background image behind the back surface portion 12b. As a result, a sense of unity of an image displayed on the display unit 11a with a background behind the liquid crystal display device 10, a floating sensation of the image, and the like are achieved.

As illustrated in FIG. 3, the lengths of the three sides of the cross-section of the lens 12 are designated as x (back surface portion 12b), y (side surface portion 12c), and z (front surface portion 12a) and a length of a part of x in which the back surface portion 12b and the front frame 11b are overlapped is designated as t. In this configuration, it is preferable that z≧2t, y≧x, and x>t be satisfied because an effect is then increased by which the width of the front frame 11b looks narrower than the actual width. These conditions may be used when the lens 12 is designed.

According to the liquid crystal display device 10 of the embodiment, the width of the front frame 11b can thus be made to look narrower than the actual width thereof through the agency of the background image of an installation site, so that a sense of unity with the background can be produced. Also, a high quality of design is attained.

The lens 12 does not have to be provided so as to cover the entire front surface of the front frame 11b as in the above example, and only has to be provided on at least a part of the front surface of the front frame 11b. For instance, the lens 12 may be provided at two sites of the left and the right of the front surface of the front frame 11b.

### Second Embodiment

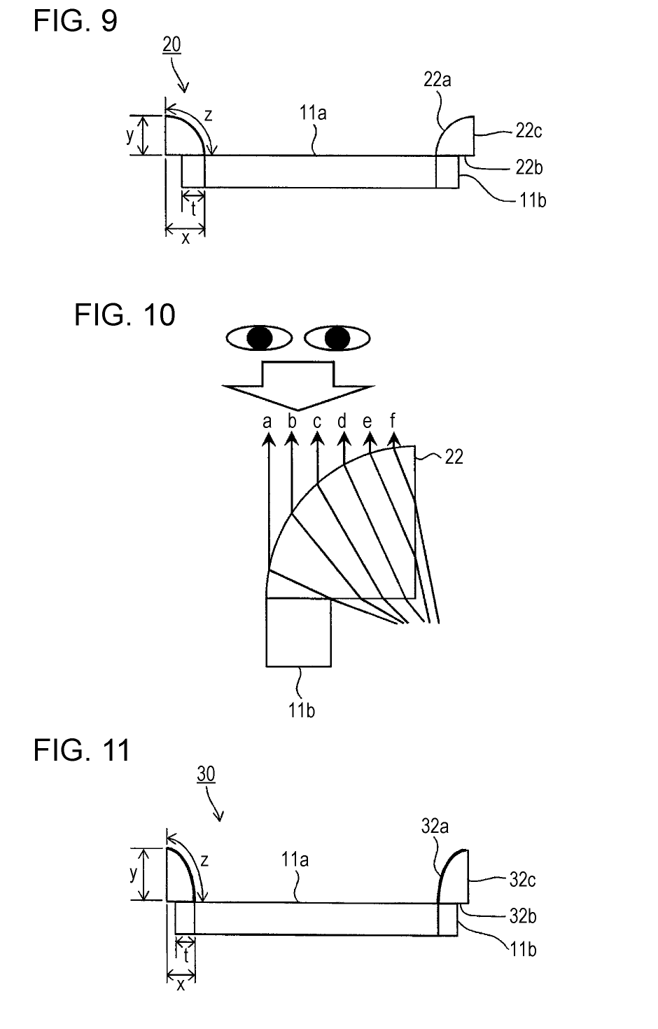

FIG. 7 is a front view of a configuration of the major parts of a liquid crystal display device according to a second embodiment of the invention; FIG. 8 is a bottom view of the same; and FIG. 9 is a cross-sectional view taken along line B-B in FIG. 7. The second embodiment is different from the first embodiment in the shape of the lens 22. Other configurations are similar to those of the first embodiment and are therefore provided with the same reference characters and detailed descriptions thereof are omitted.

In the lens 22, out of the four sides, both the left and right sides have a cross-section in the shape of an arc, and each have a spherical front surface portion 22a that is sloped so as to protrude toward the front surface side with respect to the direction from the inside to the outside of the front frame 11b, a planar back surface portion 22b that protrudes to the outside of the front frame 11b when viewed from the back surface side, and a planar side surface portion 22c that links the front surface portion 22a and the back surface portion 22b. That is, the front surface portion 22a of the lens 22 is a spherical surface that is convex toward the front surface side. A background image behind the back surface portion 22b is emitted from the front surface portion 22a.

A mechanism of the emission of the background image will be described in reference to FIG. 10. FIG. 10 is an enlarged view of a vicinity of the lens 22 of FIG. 9. When viewed from the frontal perspective of a viewer watching the front surface side, among the light rays a through f that are emitted from the front surface portion 22a of the lens 22, the light rays a through c, which are emitted from a part that overlaps the front frame 11b as viewed from the frontal perspective, and the light rays d through f, which are emitted from a part outside the front frame 11b as viewed from the frontal perspective, form the background image behind the liquid crystal display device 20.

Therefore, the background image is emitted from all parts of the lens 22, as viewed from the frontal perspective, and the front frame 11b is invisible to the viewer. As a result, a sense of unity of an image displayed on the display unit 11a with the background behind the liquid crystal display device 20, a floating sensation of the image, and the like are achieved. In addition, the background is evenly enlarged by the lens 22, and thus the background image emitted from the lens 22 is natural and free of a sense of incongruity.

As illustrated in FIG. 9, the lengths of the three sides of the cross-section of the lens 22 are respectively designated as x (back surface portion 22b), y (side surface portion 22c), and z (front surface portion 22a), and a length of a part of x, in which the back surface portion 22b and the front frame 11b are overlapped, is designated as t. In this configuration, it is preferable that z≧2t, y≧x, and x>t be satisfied because the width of the front frame 11b is then made invisible. These conditions may be used when the lens 22 is designed.

According to the liquid crystal display device 20 of this embodiment, the width of the front frame 11b can thus be made invisible through the agency of the background image of an installation site, so that a sense of unity with the background can be produced. Also, a high quality of design is attained.

The lens 22 does not have to be provided so as to cover the entire front surface of the front frame 11b as in the above example, and only has to be provided on at least a part of the front surface of the front frame 11b. For instance, the lens 22 may be provided at two sites at the left and the right of the front surface of the front frame 11b.

### Third Embodiment

FIG. 11 is a cross-sectional view of a liquid crystal display device according to the third embodiment of the invention. The third embodiment is different from the first embodiment in the shape of the lens 32. Other configurations are similar to those of the first embodiment and are therefore provided with the same reference characters and detailed descriptions thereof are omitted.

In the lens 32, out of the four sides, both the left and right sides have a cross-section that is not in the shape of an arc, and each have an aspherical front surface portion 32a that is sloped so as to protrude toward the front surface side so as to have increasing curvatures with respect to the direction from the inside to the outside of the front frame 11b, a planar back surface portion 32b that protrudes to the outside of the front frame 11b when viewed from the back surface side, and a planar side surface portion 32c that links the front surface portion 32a and the back surface portion 32b. That is, the front surface portion 32a of the lens 32 is an aspherical surface that is convex toward the front surface side. A background image behind the back surface portion 32b is emitted from the front surface portion 32a.

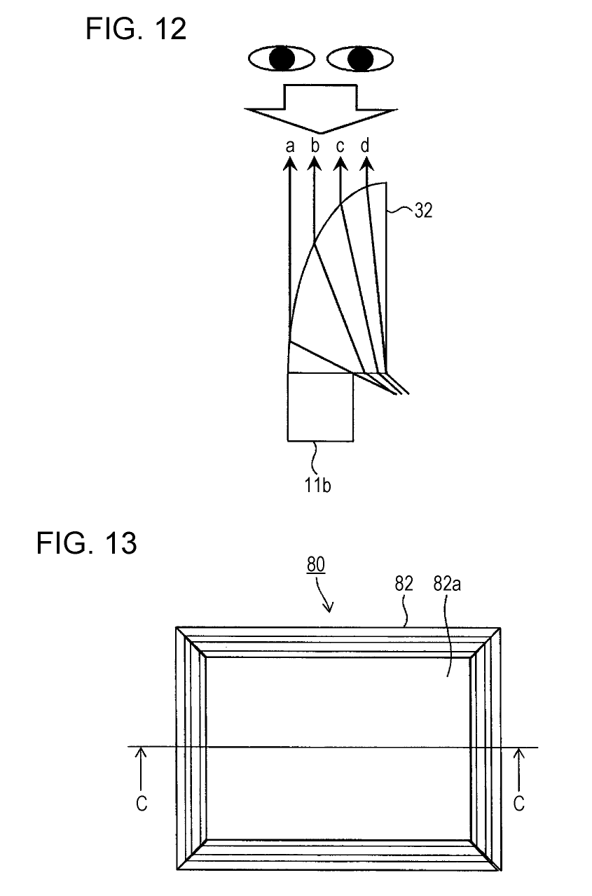

A mechanism of the emission of the background image will be described in reference to FIG. 12. FIG. 12 is an enlarged view of a vicinity of the lens 32 of FIG. 11. When viewed from the frontal perspective of a viewer watching the front surface side, among the light rays a through d that are emitted from the front surface portion 32a of the lens 32, the light rays a through c, which are emitted from a part that overlaps the front frame 11b as viewed from the frontal perspective, and a light ray d, which is emitted from a part outside the front frame 11b as viewed from the frontal perspective, form a background image behind the liquid crystal display device 30.

Therefore, the background image is emitted from all parts of the lens 32, as viewed from the frontal perspective, and the front frame 11b is invisible to the viewer. As a result, a sense of unity of an image displayed on the display unit 11a with the background behind the liquid crystal display device 30, a floating sensation of the image, and the like are achieved. With the provision of the front surface portion 32a that is an aspherical surface, the width of the lens 32 can be made narrower than the width of the lens 22 of the second embodiment.

As illustrated in FIG. 11, lengths of three sides of the cross-section of the lens 32 are respectively designated as x (back surface portion 32b), y (side surface portion 32c), and z (front surface portion 32a) and a length of a part of x, in which the back surface portion 32b and the front frame 11b are overlapped, is designated as t. In this configuration, it is preferable that z≧2t, y≧x, and x>t be satisfied because the width of the front frame 11b is then made invisible. These conditions may be used when the lens 32 is designed.

According to the liquid crystal display device 30 of the embodiment, the width of the front frame 11b can thus be made invisible through the agency of the background image of an installation site, so that a sense of unity with the background can be produced. Also, a high quality of design is attained. Furthermore, the amount of protrusion of the lens 32 toward the outside of the front frame 11b can be decreased by narrowing the width of the lens 32 in the front view.

The lens 32 does not have to be provided so as to cover the entire front surface of the front frame 11b as in the above example, and only has to be provided on at least a part of the front surface of the front frame 11b. For instance, the lens 32 may be provided at two sites which are at the left and right of the front surface of the front frame 11b.

### Fourth Embodiment

In the fourth embodiment, the shapes of top and bottom two sides of the lens 11, 22, 32 in the first through third embodiments are made similar to the shapes of the left and right two sides thereof. That is, the fourth embodiment has a configuration in which all the sides of the lens 11, 22, 32 are provided with a function of emitting the background image behind the back surface portion from the front surface portion. Thus, the widths of all sides of the front frame 11b look narrower than the actual widths thereof, or are made invisible.

Thus, a sense of unity with the background of the liquid crystal display device, a floating sensation of the image, and the like are improved in this manner by covering the entire front surface of the front frame 11b with a lens that emits the background image. Also, an improvement of design is attained.

### Fifth Embodiment

The fifth embodiment is one of the first through fourth embodiments in which the lens is formed of a resin that is lighter in weight than glass (specific gravity of 2.50 g/cm³). Polymethylmethacrylate (PMMA, specific gravity of 1.19 g/cm³) or the like may be used as the resin.

Thus, the weight of the lens may be reduced, which leads to the reduction in the weight of the liquid crystal display device. In addition, loads on members, such as the front frame 11b that hold the lens, are reduced, and thus structures, materials, and the like of the members can be simplified.

### Sixth Embodiment

The sixth embodiment is one of the first through fourth embodiments in which the lens is formed of a resin that has a higher refractive index than glass (refractive index of 1.46). In this embodiment, effects similar to those of the above embodiments can be achieved even if the lens is reduced in thickness. PMMA (refractive index of 1.49), polystyrene (PS, refractive index of 1.59), or the like may be used as the resin.

Thus, the thickness of the lens may be reduced, which leads to the reduction in the thickness of the liquid crystal display device. The reduction in the thickness of the lens has an effect of reducing the closed-in sensation of a user when viewing from the frontal perspective. Moreover, the weight of the lens can thereby be reduced, which leads to the reduction in the weight of the liquid crystal display device. In addition, the loads on the members such as the front frame 11b that hold the lens are reduced, and thus the structures, the materials, and the like of the members can be simplified.

### Seventh Embodiment

The seventh embodiment is one of the first through fourth embodiments in which the lens is formed of polycarbonate (PC). PC (bending strength of 93 MPa) is stronger against bending than glass (bending strength of 49 Mpa) and thus increases shock resistance (bending strength) of the lens.

In this manner, increasing the shock resistance of the lens leads to an increase in shock resistance of the liquid crystal display device. In addition, the weight of the lens can thereby be reduced which leads to the reduction in the weight of the liquid crystal display device. Furthermore, the loads on the members such as the front frame 11b that hold the lens are reduced, and thus the structures, the materials, and the like of the members can be simplified.

### Eighth Embodiment

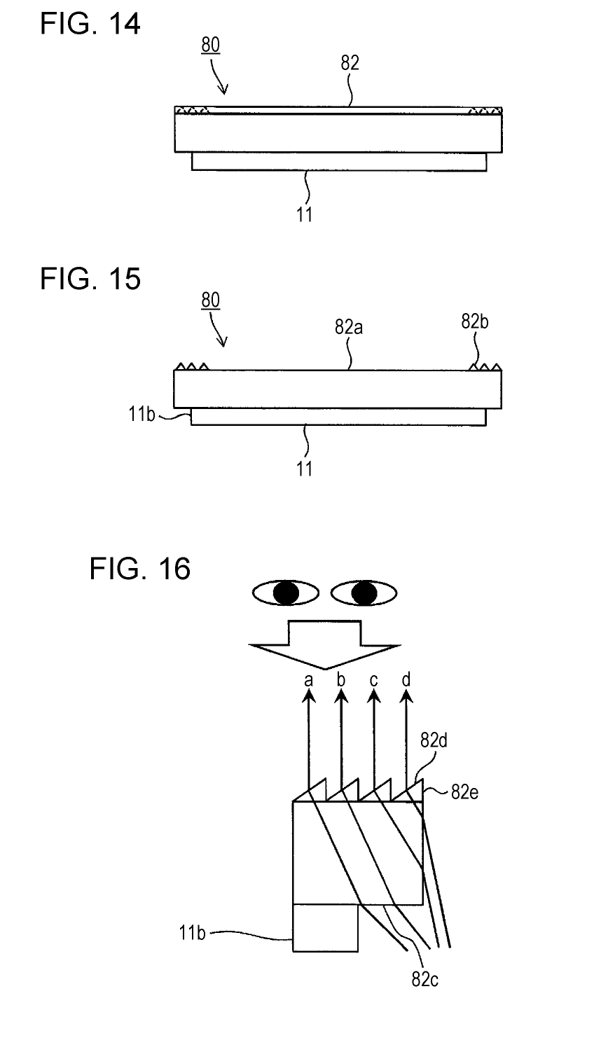

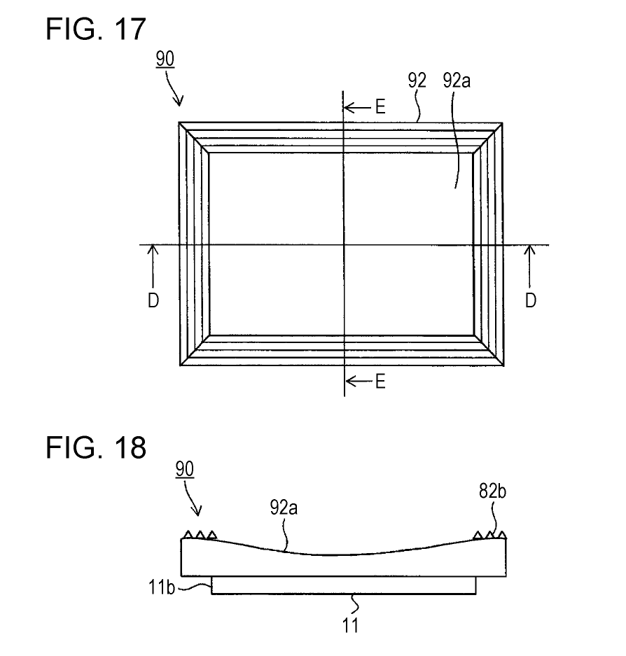

FIG. 13 is a front view of a configuration of a major part of a liquid crystal display device according to the eighth embodiment of the invention; FIG. 14 is a bottom view of the same; FIG. 15 is a cross-sectional view taken along line C-C in FIG. 13, and FIG. 16 is an enlarged view of a vicinity of a lens of FIG. 15. The eighth embodiment is different from the first embodiment in the shape of the lens 82. Other configurations are similar to those of the first embodiment and are therefore provided with the same reference characters and detailed descriptions thereof are omitted.

The lens 82 is formed of a transparent flat resin plate 82a, which is made of PC or the like and covers the front surfaces of the display unit 11a and the front frame 11b, and a linear Fresnel lens 82b, integrally molded on the front surfaces side of the flat resin plate 82a, shaped as a picture frame, which is made of PC or the like and covers the front surface of the front frame 11b. The flat resin plate 82a has a planar back surface portion 82c that protrudes to the outside of the front frame 11b when viewed from the back surface side.

The linear Fresnel lens 82b is formed along the sides of the front frame 11b and has a cross-section in the shape of a plurality of triangles. The shape of each of the triangles corresponds to a reduced cross-section of the lens 12 of the first embodiment. That is, the shape of each of the triangles has a planar front surface portion 82d that is sloped so as to protrude toward the front surface side with respect to the direction from the inside to the outside of the front frame 11b. The lens 82 has a planar side surface portion 82e that links the front surface portion of the linear Fresnel lens 82b and the back surface portion of the flat resin plate 82a. A background image behind the back surface portion 82c is emitted from the front surface portion 82d.

Alternatively, the shape of the cross-section of the linear Fresnel lens 82b may be spherical as in the second embodiment or aspherical as in the third embodiment, instead of being triangular.

A mechanism of emission of the background image will be described in reference to FIG. 16. When viewed from the frontal perspective of a viewer watching the front surface side, among the light rays a through d that are emitted from the front surface portion 82d of the linear Fresnel lens 82b, the light rays a and b, which are emitted from a part that overlaps the front frame 11b as viewed from the frontal perspective, and the light rays c and d, which are emitted from a part outside the front frame 11b as viewed from the frontal perspective, form the background image behind the liquid crystal display device 80.

Therefore, the background image is emitted from all parts of the linear Fresnel lens 82b as viewed from the frontal perspective, and the front frame 11b is invisible to the viewer. As a result, a sense of unity of an image displayed on the display unit 11a with the background of the liquid crystal display device 80, a floating sensation of for the image, and the like are achieved.

According to the liquid crystal display device 80 of the embodiment, the width of the front frame 11b can thus be made invisible through the agency of the background image of an installation site, so that a sense of unity with the background can be produced. Also, the quality of design is high.

Use of the linear Fresnel lens 82b can reduce the thickness of the lens, and thus lead to the reduction in thickness of the liquid crystal display device 80. The use of the linear Fresnel lens 82b has the effect of reducing the closed-in sensation of the user when viewing from the frontal perspective. In addition, the weight of the lens may thereby be reduced, thus leading to the reduction in the weight of the liquid crystal display device. Furthermore, the loads on the members such as the front frame 11b that hold the lens are reduced, and thus the structures, the materials, and the like of the members can be simplified.

Moreover, the display unit 11a can be protected by the use of the flat resin plate 82a. By the provision of the thin linear Fresnel lens 82b on the flat resin plate 82a, the front surface side of the liquid crystal display device 80 can generally be flattened, and thus the quality of design is improved by eliminating the perception of a picture frame.

The linear Fresnel lens 82b does not have to be provided so as to cover the entire front surface of the front frame 11b as in an above example, and only has to be provided on at least a part of the front surface of the front frame 11b. For instance, the linear Fresnel lens 82b may be provided at two sites which are at the left and right of the front surface of the front frame 11b. The flat resin plate 82a is not necessarily required.

### Ninth Embodiment

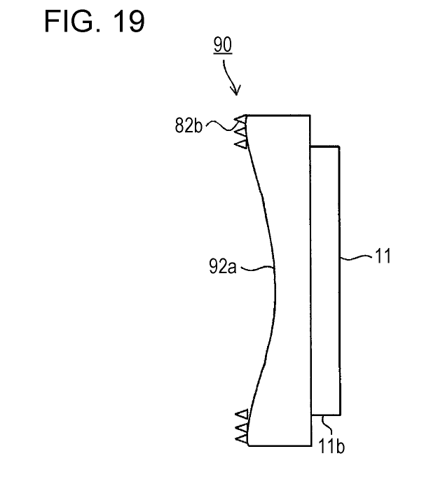

FIG. 17 is a front view of a configuration of the major parts of a liquid crystal display device according to the ninth embodiment of the invention; FIG. 18 is a cross-sectional view taken along line D-D in FIG. 17; and FIG. 19 is a cross-sectional view taken along line E-E in FIG. 17. The ninth embodiment is different from the eighth embodiment in the shape of the lens 92. Other configurations are similar to those of the eighth embodiment and are therefore provided with the same reference characters and detailed descriptions thereof are omitted.

In the lens 92 of this embodiment, the flat resin plate 82a of the lens 82 of the eighth embodiment is replaced by a concave lens plate 92a. The linear Fresnel lens 82b is similar to that of the eighth embodiment. The concave lens plate 92a is smoothly sloped toward center thereof and has a shape that is most deeply recessed in the center part.

According to the liquid crystal display device 80 of this embodiment, a sense of immersion in a displayed image is achieved from an effect of the concave lens plate 92a, in addition to the effects similar to those of the eighth embodiment.

### Tenth Embodiment

The tenth embodiment is one of the first through ninth embodiments in which the liquid crystal module 11 is replaced by a white liquid crystal module that uses a color-filter-less transparent liquid crystal panel (normally white). The white liquid crystal module takes on a white-based display color (depending on color of an optical sheet on a back surface of the transparent liquid crystal panel) in a power-off state, and thus reduces the closed-in sensation compared to configurations that use a liquid crystal panel (normally black), which takes on a black-based display color in the power-off state.

### Eleventh Embodiment

The eleventh embodiment is one of the first through ninth embodiments in which the liquid crystal module 11 is replaced by a transparent liquid crystal module. The transparent liquid crystal module takes on a transparent display color in the power-off state, and thus the background of the liquid crystal display device is emitted from the display unit.

Therefore, even when, for example, an image is displayed on a part of the display unit, a floating sensation is achieved because the surroundings of the image are transparent so the background can be seen therethrough. In addition, the closed-in sensation can be reduced compared to configurations that use the white liquid crystal module, which takes on a white-based display color in the power-off state.

Hereinafter, the various embodiments of the invention will be summarized. The display device 10 according to one embodiment of the invention has a configuration including the display unit 11a, the casing (front frame 11b) that is provided on the periphery of the display unit 11a, and the lens 12 that includes the front surface portion 12a, which is provided on at least the part of the front surface of the casing and which is sloped so as to protrude toward the front surface side with respect to the direction from the inside to the outside of the casing, and the back surface portion 12b, which protrudes to the outside of the casing when viewed from the back surface side, emitting the background image behind the back surface portion 12b from the front surface portion 12a.

According to this configuration, the width of the casing can be made to look narrower than the actual width thereof through the agency of the background image of the installation site, so that a sense of unity with the background can be produced. Also, a high quality of design is attained.

In the display device, the front surface portion of the lens may be the spherical surface that is convex toward the front surface side.

According to this configuration, the width of the casing can be made invisible through the agency of the background image of the installation site, so that a sense of unity with the background can be produced. Also, a high quality of design is attained.

In the display device, the front surface portion of the lens may be an aspherical surface that is convex toward the front surface side and that has increasing curvatures with respect to the direction toward the outside of the casing.

According to this configuration, the width of the casing can be made invisible through the agency of the background image of the installation site, so that a sense of unity with the background can be produced. Also, a high quality of design is attained. Furthermore, the amount of protrusion of the lens to the outside of the casing can be decreased with the decrease in the width of the lens in the front view.

In the display device, the lens may cover the entire front surface of the casing.

According to this configuration, a sense of unity with the background of the liquid crystal display device, a floating sensation of the image, and the like are improved. Also, an improved design is attained.

In the display device, the lens may be formed of resin that is lighter in weight than glass.

According to this configuration, the weight of the lens may be reduced, which leads to the reduction in the weight of the display device. In addition, the loads on the members, such as the casing that hold the lens, are reduced, and thus the structures, the materials, and the like of the members can be simplified.

In the display device, the lens may be formed of a resin that has a higher refractive index than glass.

According to this configuration, the thickness of the lens may be reduced, which leads to the reduction in the thickness of the display device. The reduction in the thickness of the lens has the effect of reducing the closed-in sensation of a user when viewing from the frontal perspective. In addition, the weight of the lens may be reduced, which leads to the reduction in the weight of the display device. Furthermore, the loads on the members, such as the casing that hold the lens, are reduced, and thus the structures, the materials, and the like of the members can be simplified.

In the display device, the lens may be formed of polycarbonate.

According to this configuration, the increase in the shock resistance of the lens is attained, thus leading to the increase in the shock resistance of the display device. In addition, the weight of the lens may be reduced, which leads to the reduction in the weight of the display device. Furthermore, the loads on the members, such as the casing that hold the lens, are reduced, and thus the structures, the materials, and the like of the members can be simplified.

In the display device, the lens may be a linear Fresnel lens.

According to this configuration, the thickness of the lens may be reduced, thus leading to the reduction in the thickness of the display device. The configuration has the effect of reducing the closed-in sensation of a user when viewing from the frontal perspective. In addition, the weight of the lens can be reduced, which leads to the reduction in the weight of the liquid crystal display device. Furthermore, the loads on the members such as the casing that hold the lens are reduced, and thus the structures, the materials, and the like of the members can be simplified.

In the display device, a concave lens may be provided on the front surface of the display unit.

According to this configuration, the sense of immersion in the displayed image is achieved.

In the display device, the display unit may be formed of a white liquid crystal module using a color-filter-less transparent liquid crystal panel.

According to this configuration, a white-based display color is displayed in the power-off state, and thus the closed-in sensation is thereby reduced compared to configurations in which the liquid crystal panel uses a black-based display color in the power-off state.

In the display device, the display unit may be formed of a transparent liquid crystal module.

According to this configuration, when an image is displayed on a part of the display unit, a floating sensation is achieved because the surroundings of the image are transparent, so that the background can be seen therethrough. In addition, the closed-in sensation can be reduced compared to configurations in which the white liquid crystal module uses a white-based display color in the power-off state.

### INDUSTRIAL APPLICABILITY

The invention can be used for various display devices, such as a liquid crystal display device and an organic or inorganic EL display device, which include a casing in the shape of a picture frame.

### LIST OF REFERENCE CHARACTERS

10, 20, 30, 80, 90 liquid crystal display device
11a display unit
11b front frame (casing)
12, 22, 32, 82, 92 lens
12a, 22a, 32a, 82d front surface portion
12b, 22b, 32b, 82c back surface portion
82b linear Fresnel lens
92a concave lens plate (concave lens)

1. A display device comprising:
a display unit;
a casing that is provided on a periphery of the display unit; and
a lens that includes a front surface portion, which is provided on at least a part of a front surface of the casing and which is sloped so as to protrude toward a front surface side with respect to a direction from inside to outside of the casing, and a back surface portion which protrudes to the outside of the casing when viewed from a back surface side, and that emits a background image behind the back surface portion from the front surface portion.

2. The display device according to claim 1, wherein the front surface portion of the lens is a spherical surface that is convex toward the front surface side.

3. The display device according to claim 1, wherein the front surface portion of the lens is an aspherical surface that is convex toward the front surface side and that has increasing curvatures with respect to a direction toward the outside of the casing.

4. The display device according to claim 1, wherein the lens covers an entire front surface of the casing.

5. The display device according to claim 1, wherein the lens is formed of a resin that is lighter in weight than glass.

6. The display device according to claim 1, wherein the lens is formed of a resin that has a higher refractive index than glass.

7. The display device according to claim 1, wherein the lens is formed of polycarbonate.

8. The display device according to claim 1, wherein the lens is a linear Fresnel lens.

9. The display device according to claim 1, wherein a concave lens is provided on a front surface of the display unit.

10. The display device according to claim 1, wherein the display unit is formed of a white liquid crystal module that uses a color-filter-less transparent liquid crystal panel.

11. The display device according to claim 1, wherein the display unit is formed of a transparent liquid crystal module.
